(19) United States
(12) Patent Application Publication
(10) Pub. No.: US 2007/0116816 A1
(43) Pub. Date: May 24, 2007

(54) Cooking apparatus and method

(75) Inventors: Kwang Keun Kim, Yongin-si (KR); Jeong Han Kim, Suwon-si (KR); Suk Hee Lee, Suwon-si (KR)

Correspondence Address: STAAS & HALSEY LLP, SUITE 700, 1201 NEW YORK AVENUE, N.W., WASHINGTON, DC, 20005, US

(73) Assignee: Samsung Electronics Co., Ltd., Suwon-si (KR)

(21) Appl. No.: 11/475,054

(22) Filed: Jun. 27, 2006

(30) Foreign Application Priority Data
Nov. 19, 2005 (KR) 2005-111062

(51) Int. Cl. A23C 3/00

(52) U.S. Cl. 426/523

(57) ABSTRACT

Disclosed herein is a cooking apparatus and method. The cooking method includes storing thawing information to thaw various kinds of food to be cooked in a memory of a cooking apparatus, reading and interpreting a bar code, indicated on a package of the food to be cooked, storing kinds of food and cooking information for the food to be cooked, confirming the stored state of the food to be cooked, and, when the kind of food for the food to be cooked is food designed to be chilled and the food to be cooked is frozen, thawing the food to be cooked according to the thawing information, and performing a cooking process based on the cooking information.

### CROSS-REFERENCE TO RELATED APPLICATIONS

This application claims the benefit of Korean Patent Application No. 2005-111062, filed on Nov. 19, 2005 in the Korean Intellectual Property Office, the disclosure of which is incorporated herein by reference.

### BACKGROUND OF THE INVENTION

1. Field of the Invention

The present invention relates to a cooking apparatus and method, and, more particularly, to a cooking apparatus and method that is capable of cooking food after adding or subtracting a thawing process based on the current storage state of the food to be cooked when the current storage state of the food is different from the predetermined storage state of the food.

2. Description of the Related Art

Generally, cooking apparatuses are devices that cook food using various heating sources. Based on heating sources, cooking apparatuses are classified into several types of cooking apparatuses. For example, a microwave oven is a cooking apparatus that cooks food using microwaves. In the conventional microwave oven, a user directly inputs cooking time, cooking mode, and kinds of food to be cooked through the use of a key input unit formed at the front panel of the microwave oven. In other words, it is necessary that the user manually input cooking information. Consequently, appropriate cooking conditions are not easily and conveniently set.

For this reason, a microwave oven has been developed that is capable of reading a bar code storing cooking information, which is attached to a food package, and cooking food based on the cooking information stored in the bar code. Such a microwave oven is disclosed in Korean Unexamined Patent Publication No. 2001-0010530. Also, another microwave oven has developed that is capable of storing cooking information on various kinds of food in a memory and, when a user selects food to be cooked, cooking the food based on the cooking information stored in the memory.

However, the microwave oven using the bar code has a problem in that, when food, designed to be chilled, is frozen, the food is cooked based on the cooking conditions suitable to the chilled state, and therefore, the food is not appropriately cooked. Specifically, the cooking conditions stored in the bar code printed on the food package are set such that the food can be optimally cooked when it is chilled. Consequently, when the wrongly frozen food, which should have been chilled, is cooked according to the cooking conditions stored in the bar code without leaving the food to thaw before cooking, the food is not optimally cooked.

In order to solve the above-mentioned problem, Korean Patent Application No. 2004-53090 (filed Jul. 8, 2004) proposes a cooking apparatus and method, wherein, when food to be cooked, designed to be chilled, is frozen, the food is not directly cooked based on cooking conditions read by a bar-code reader, but the food is thawed to change the state of the food and then cooked.

However, the proposed cooking apparatus and method has been developed in order to solve only the problem in that, when food, designed to be chilled, is frozen, and is directly cooked, the food is not appropriately cooked. Consequently, the proposed cooking apparatus and method cannot solve a problem in that, when food, designed to be frozen, is chilled or stored at room temperature, and is directly cooked, the food is not appropriately cooked. In this case, the food designed to be frozen does not need to be thawed before cooking, but the food is thawed based on the cooking information of the food designed to be frozen, including thawing information, and is then cooked. As a result, the food is overcooked.

Also, it is premised that the thawing information is stored in a bar code according to the proposed cooking apparatus and method. However, it is difficult to expect thawing information to be stored in a bar code of food designed to be chilled; rather, it is more realistic that thawing information be stored in a memory of a cooking apparatus. Consequently, the necessity of a cooking apparatus with thawing information stored in a memory comes to the fore.

When food is selected and cooked in the microwave oven having cooking information on various kinds of food stored in the memory, the following problem is raised. When the food, designed to be chilled, is frozen, or the food, designed to be frozen, is chilled, and is directly cooked, the food is not appropriately cooked. This is because, when cooking information to be stored in a memory is set by microwave oven manufacturers, cooking information of food designed to be chilled is set on the premise that the food designed to be chilled is generally in chilled storage, and cooking information (including a thawing process) of food designed to be frozen is set on the premise that the food designed to be frozen is generally in frozen storage.

### SUMMARY OF THE INVENTION

Therefore, it is an aspect of the invention to provide a cooking apparatus and method that is capable of cooking food after adding or subtracting a thawing process when the food is in the state that it is not appropriate to cook in the case that the food is automatically cooked based on cooking information stored in a bar code or a memory of the cooking apparatus.

In accordance with one aspect, the present invention provides a cooking method including: storing thawing information to thaw various kinds of food to be cooked in a memory of a cooking apparatus; reading and interpreting a bar code, indicated on a package of the food to be cooked, storing kinds of food and cooking information for the food to be cooked; confirming the stored state of the food to be cooked; and, when the kind of food for the food to be cooked is food designed to be chilled and the food to be cooked is frozen, thawing the food to be cooked according to the thawing information, and performing a cooking process based on the cooking information.

The stored state of the food to be cooked includes a chilled state and a frozen state.

The stored state of the food to be cooked is confirmed by input information obtained by a user's input of the state of the food to be cooked in response to a message requesting the user to input the state of the food to be cooked in the cooking apparatus.

The thawing information includes thawing time set for each food to be cooked or power level of the cooking apparatus.

The bar code stores food name, and the thawing information of the food to be cooked is confirmed by interpreting the bar code in the cooking apparatus to confirm the name of the food to be cooked and searching for thawing information of the food to be cooked having the corresponding food name in the memory.

The cooking method further includes: when the kind of food for the food to be cooked is food designed to be chilled and the food to be cooked is chilled, performing a cooking process based on the cooking information without thawing the food to be cooked.

In accordance with another aspect, the present invention provides a cooking method including: reading and interpreting a bar code, indicated on a package of food to be cooked, storing kinds of food, cooking information, and thawing information for the food to be cooked; confirming the stored state of the food to be cooked; and, when the kind of food for the food to be cooked is food designed to be frozen and the food to be cooked is chilled, performing a cooking process based on the other cooking information without thawing the food to be cooked.

The stored state of the food to be cooked includes a chilled state and a frozen state.

The stored state of the food to be cooked is confirmed by input information obtained by a user's input of the state of the food to be cooked in response to a message requesting the user to input the state of the food to be cooked in the cooking apparatus.

The cooking method further includes: when the kind of food for the food to be cooked is food designed to be frozen and the food to be cooked is frozen, thawing the food to be cooked according to the thawing information, and performing a cooking process based on the cooking information.

In accordance with another aspect, the present invention provides a cooking apparatus including: a bar-code reader to read a bar code, indicated on a package of food to be cooked, storing kinds of food and cooking information for the food to be cooked; a memory to store thawing information of food designed to be chilled, which is a kind of the food to be cooked; a control unit to interpret the kind of food and the cooking information read by the bar-code reader and control the food to be thawed according to the thawing information stored in the memory and to be cooked based on the cooking information; and a driving unit to perform a cooking process according to a control command from the control unit.

The thawing information includes thawing time set for each food to be cooked or power level of the driving unit.

The bar code stores food name, and, when the food to be cooked, designed to be chilled, is frozen, the control unit interprets the bar code to confirm the name of the food to be cooked and confirms thawing information of the food to be cooked having the corresponding food name in the memory.

The cooking apparatus further includes: a display unit to display a message requesting a user to input the state of the food to be cooked, i.e., the chilled state or the frozen state.

The cooking apparatus further includes: an input unit having a chilled-state button, which is selected by the user when the food to be cooked is chilled, and a frozen-state button, which is selected by the user when the food to be cooked is frozen.

In accordance with another aspect, the present invention provides a cooking apparatus including: a bar-code reader to read a bar code, indicated on a package of food to be cooked, storing kinds of food, cooking information, and thawing information for the food to be cooked; a control unit to interpret the cooking information read by the bar-code reader and, when the food to be cooked, designed to be frozen, is chilled, control the food to be cooked based on the cooking information without thawing the food to be cooked; and a driving unit to perform a cooking process according to a control command from the control unit.

The cooking apparatus further includes: a display unit to display a message requesting a user to input the state of the food to be cooked, i.e., the chilled state or the frozen state.

The cooking apparatus further includes: an input unit having a chilled-state button, which is selected by the user when the food to be cooked is chilled, and a frozen-state button, which is selected by the user when the food to be cooked is frozen.

In accordance with another aspect, the present invention provides a cooking method including: storing kinds of food, cooking information, and thawing information for food to be cooked in a memory of a cooking apparatus; searching for the cooking information of food to be cooked, which is selected by a user, in the memory; confirming the stored state of the food to be cooked; and, when the kind of food for the food to be cooked is food designed to be chilled and the food to be cooked is frozen, thawing the food to be cooked according to the thawing information stored in the memory, and performing a cooking process based on the cooking information stored in the memory.

The cooking method further includes: when the kind of food for the food to be cooked is food designed to be chilled and the food to be cooked is chilled, performing a cooking process based on the cooking information without thawing the food to be cooked.

In accordance with another aspect, the present invention provides a cooking method including: storing kinds of food, cooking information, and thawing information for food to be cooked in a memory of a cooking apparatus; searching for the cooking information of food to be cooked, which is selected by a user, in the memory; confirming the stored state of the food to be cooked; and, when the kind of food for the food to be cooked is food designed to be frozen and the food to be cooked is chilled, performing a cooking process based on the other cooking information stored in the memory excluding the thawing information.

The stored state of the food to be cooked includes a chilled state and a frozen state, and the stored state of the food to be cooked is confirmed by input information obtained by a user's input of the state of the food to be cooked in response to a message requesting the user to input the state of the food to be cooked in the cooking apparatus.

In accordance with another aspect, the present invention provides a cooking apparatus including: a memory to store kinds of food, cooking information, and thawing information for food to be cooked; an input unit having a chilled-state button, which is selected when the food to be cooked is chilled, and a frozen-state button, which is selected when the food to be cooked is frozen; a control unit to control the food to be thawed according to the thawing information and then the food to be cooked based on the cooking information, when the kind of food for the food to be cooked is food designed to be chilled and the food to be cooked is frozen; and a driving unit to perform a cooking process according to a control command from the control unit.

In accordance with yet another aspect, the present invention provides a cooking apparatus including: a memory to store kinds of food, cooking information, and thawing information for food to be cooked; an input unit having a chilled-state button, which is selected when the food to be cooked is chilled, and a frozen-state button, which is selected when the food to be cooked is frozen; a control unit to control the food to be cooked based on the other cooking information excluding the thawing information without thawing the food to be cooked, when the kind of food for the food to be cooked is food designed to be frozen and the food to be cooked is chilled; and a driving unit to perform a cooking process according to a control command from the control unit.

The cooking apparatus further includes: a display unit to display a message requesting a user to input the state of the food to be cooked.

Additional aspects and/or advantages of the invention will be set forth in part in the description which follows and, in part, will be apparent from the description, or may be learned by practice of the invention.

### BRIEF DESCRIPTION OF THE DRAWINGS

These and/or other aspects and advantages of the invention will become apparent and more readily appreciated from the following description of the embodiments, taken in conjunction with the accompanying drawings, of which:

FIG. 1 is a front view showing a microwave oven, which is a kind of cooking apparatus according to a first embodiment of the present invention;

FIG. 2 is a control block diagram of the microwave oven shown in FIG. 1;

FIG. 3 is a view illustrating cooking information stored in a bar code printed on a package of food designed to be chilled;

FIG. 4 is a view illustrating cooking information stored in a bar code printed on a package of food designed to be frozen;

FIG. 5 is a flow chart illustrating a cooking method according to a first embodiment of the present invention;

FIG. 6 is a front view showing a microwave oven, which is a kind of cooking apparatus according to a second embodiment of the present invention;

FIG. 7 is a control block diagram of the microwave oven shown in FIG. 6; and

FIG. 8 is a flow chart illustrating a cooking method according to a second embodiment of the present invention.

### DETAILED DESCRIPTION OF THE PREFERRED EMBODIMENTS

Reference will now be made in detail to the embodiment of the present invention, examples of which are illustrated in the accompanying drawings, wherein like reference numerals refer to like elements throughout. The embodiment is described below to explain the present invention by referring to the figures.

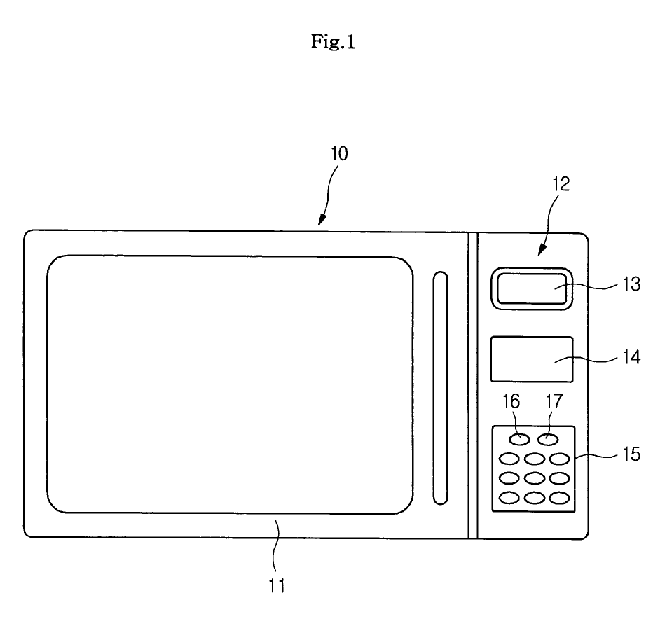

Referring to FIG. 1, a microwave oven, which is a kind of cooking apparatus according to a first embodiment of the present invention, includes a door 11 disposed in front of an oven body 10 and a front panel 12 disposed at the right side of the door 11.

The front panel 12 includes a display unit 13 disposed at the upper part thereof to display the operation of the microwave oven, a built-in bar-code reader 14 disposed below the display unit 13 to read a bar code, and an input unit 15 disposed below the bar-code reader 14. The input unit 15 has a plurality of input buttons. For example, the input unit 15 has a chilled-state button 16, a frozen-state button 17, and other buttons for a user to input control commands.

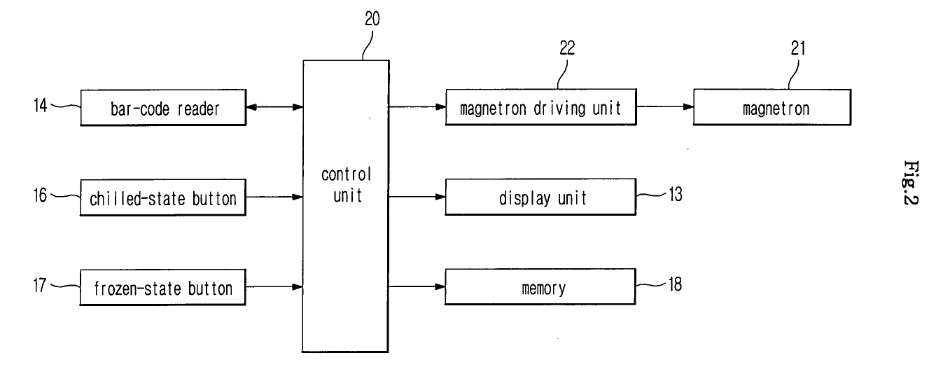

The chilled-state button 16 and the frozen-state button 17 are used for the user to input the state of food to be cooked. When the food to be cooked is in chilled storage, a user presses the chilled-state button 16. When the food to be cooked is in frozen storage, the user presses the frozen-state button 17. When the chilled-state button 16 or the frozen-state button 17 is pressed, the state of the food to be cooked is transmitted to a control unit 20 (See FIG. 2), which will be described below.

Referring to FIG. 2, the microwave oven shown in FIG. 1 further includes a magnetron-driving unit 22 to drive a magnetron 21 that generates microwaves to be supplied to a cooking chamber (not shown), a control unit 20 to interpret a bar code read by the bar-code reader 14 to confirm cooking information stored in the bar code and control the respective components of the microwave oven such that the food is cooked according to the cooking information, and a memory 18 to store thawing information of food designed to be chilled.

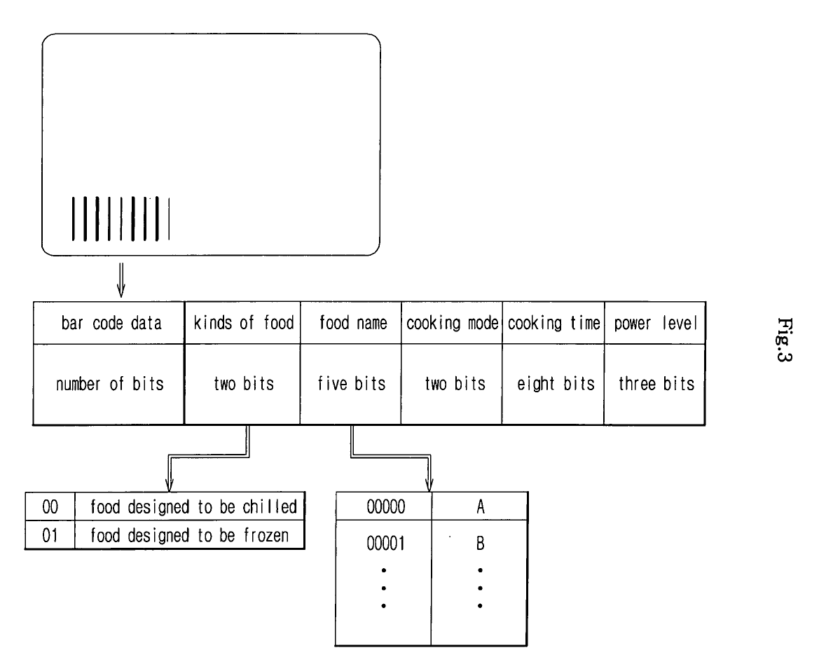

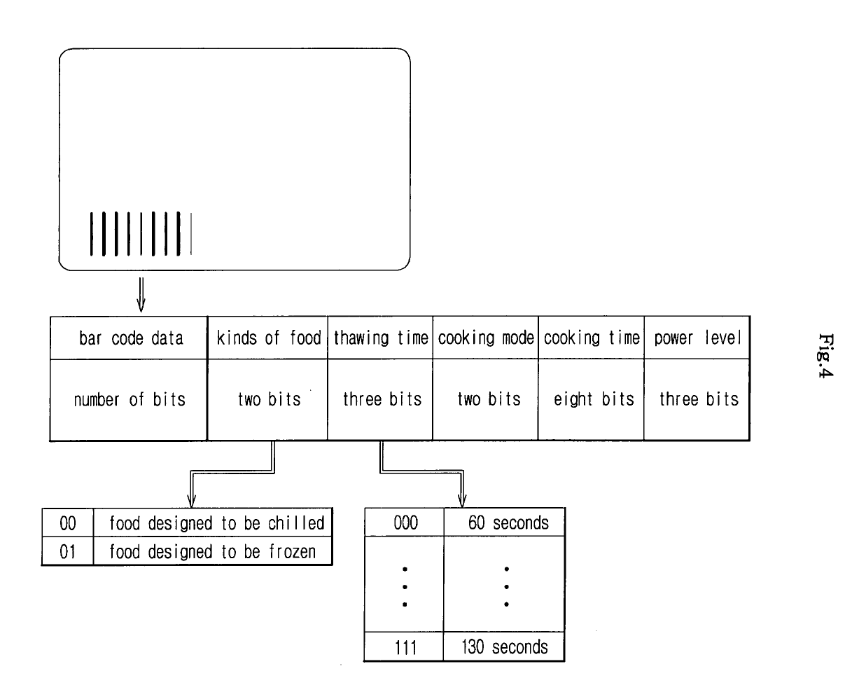

The contents of cooking information stored in the bar code used in this embodiment are different based on whether the bar code is used for food designed to be chilled or food designed to be frozen. Specifically, as shown in FIG. 3, the bar code used for the food designed to be chilled stores cooking information including kinds of food, food name, and various cooking conditions. Also, as shown in FIG. 4, the bar code used for the food designed to be frozen stores cooking information including kinds of food, thawing time, and various cooking conditions.

Based on kinds of food, food having a printed bar code is classified into food designed to be chilled, which is necessary to be kept in chilled storage, and food designed to be frozen, which is necessary to be kept in frozen storage. Different bar code values are given according to kinds of food. For example, two bits are assigned to the bar code to store the kinds of food. When the two-bit bar code is read “00,” it is determined that the food is designed to be chilled. When the two-bit bar code is read “01,” it is determined that the food is designed to be frozen. In this case, as shown in FIG. 3, the kind of food of the bar code used for food designed to be chilled is indicated “00,” and, as shown in FIG. 4, the kind of food of the bar code used for food designed to be frozen is indicated “01.”

The food name is information for the control unit to confirm food to be cooked. In other words, the food name serves as identification (ID) of the food to be cooked. For example, five bits are assigned to the bar code to store the food name. When the five-bit bar code is read “00 000,” it is indicated that the food to be cooked is A. When the five-bit bar code is read “00 001,” it is indicated that the food to be cooked is B.

The thawing time is set to thaw food designed to be frozen before the food is cooked. For example, as shown in FIG. 4, three bits are assigned to the bar code for storing the thawing time. When the bar code is read “000,” it is determined that the thawing time is 60 seconds. When the bar code is read “111,” it is determined that the thawing time is 130 seconds. The thawing time may vary depending upon kinds of food to be cooked.

The cooking conditions include cooking mode, such as cooking by microwaves or grill cooking by an electric heater mounted in the microwave oven, cooking time, and power level to decide the output of the magnetron.

The control unit 20 stores interpreting rules to read the bar codes shown in FIGS. 3 and 4. Specifically, the interpreting rules prescribe what cooking information each line of the bar code stores, and what the detailed contents of the cooking information corresponding to the value of the read bar code are.

The thawing information stored in the memory 18 includes thawing time and power level during thawing, as indicated in Table 1 below. The thawing information is given for each food designed to be chilled. The power level indicated in Table 1 is a power level supplied to the magnetron during thawing, which is expressed by percentage of the maximum power.

TABLE 1

Thawing information

| Food name | Thawing time | Power level |
|---|---|---|
| A | 160 seconds | 50% |
| B | 220 seconds | 60% |
| . . . | . . . | . . . |

A flash memory having easy input and output of data may be used as the above-mentioned memory such that, whenever new food designed to be chilled comes into the market, thawing information of the food can be easily stored in the memory. In this case, the thawing information stored in the flash memory may be updated in various manners, an example of which is disclosed in Korean Unexamined Patent Publication No. 2002-78335 (Data processing method of internet microwave oven memory pack).

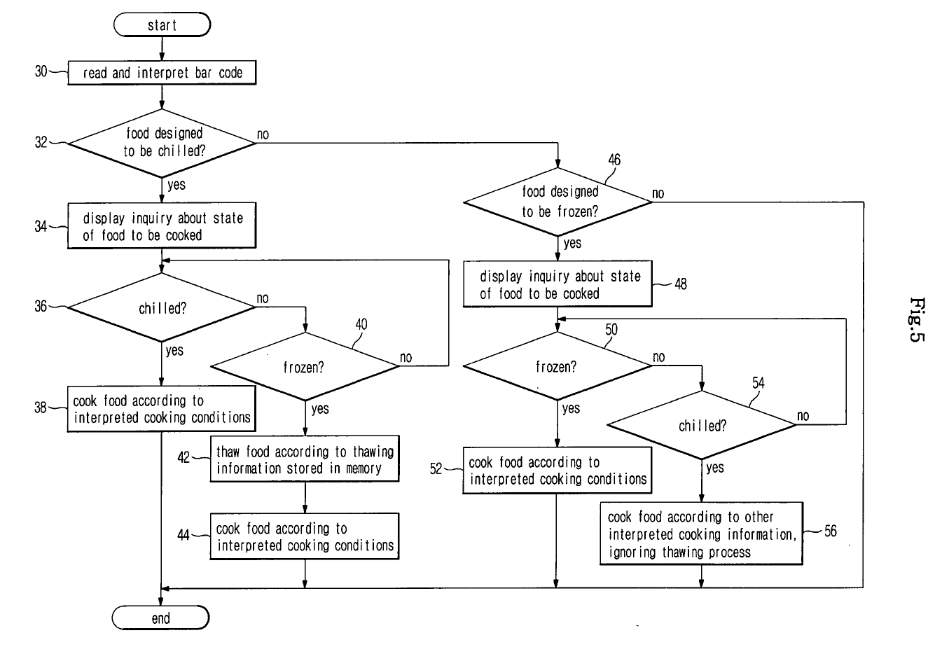

Now, a cooking method according to a first embodiment of the present invention will be described with reference to FIG. 5. When a user brings a bar code printed on a food package to the bar-code reader 14, the bar-code reader 14 reads the bar code, and the control unit 20 interprets cooking information stored in the bar code using the interpreting rules (30).

Upon completion of the interpretation of the bar code, the control unit 20 determines, referring to the kinds of food, whether the food to be cooked is designed to be chilled (32). When it is determined that the food to be cooked is designed to be chilled, an inquiry about the state of the food is displayed on the display unit 13 so that the user can input the state of the food designed to be chilled (34). When the food designed to be chilled is chilled, the user presses the chilled-state button 16 of the input unit 15. When the food designed to be chilled is frozen, the user presses the frozen-state button 17 of the input unit 15.

Subsequently, the control unit 20 determines whether the chilled-state button 16 is pressed by the user (i.e., the food designed to be chilled is chilled) (36). When it is determined that the chilled-state button 16 is pressed by the user, the control unit 20 interprets that the food designed to be chilled is chilled, and thus a cooking process is preformed according to the interpreted cooking conditions (38). When it is determined that the chilled-state button 16 is not pressed, on the other hand, the control unit 20 determines whether the frozen-state button 17 is pressed by the user (i.e., the food designed to be chilled is frozen) (40).

When it is determined that the frozen-state button 17 is not pressed, the procedure is returned to Operation 36. When it is determined that the frozen-state button 17 is pressed by the user, on the other hand, the control unit 20 interprets the bar code to search for the thawing information of the food designed to be chilled having the corresponding food name in the memory 18. Then, the control unit 20 drives the magnetron 21 at the power level of the thawing information for the thawing time of the thawing information to thaw the food designed to be chilled, which is frozen (42). After the food is thawed, and is then changed into the state in which the food can be appropriately cooked, the cooking process is carried out according to the interpreted cooking conditions (cooking mode, cooking time, power level) (44).

As can be easily understood from the above description, food is not directly cooked based on the interpreted cooking conditions when the food, designed to be chilled, is frozen. The food designed to be chilled, which is frozen, is thawed according to the thawing information stored in the memory 18 such that the state of the food designed to be chilled, which is frozen, is similar to the chilled storage state of the food designed to chilled, and is then cooked based on the cooking conditions. Consequently, the food is optimally cooked.

Meanwhile, when it is determined at Operation 32 that the food to be cooked is not designed to be chilled, the control unit 20 determines whether the food to be cooked is designed to be frozen (46). When it is determined that the food to be cooked is not designed to be frozen, the control unit 20 determines that it is unnecessary for the present invention to be applied to the food to be cooked, or an error occurs during the bar code reading or interpretation, and the procedure is terminated. When it is determined that the food to be cooked is designed to be frozen, on the other hand, an inquiry about the state of the food is displayed on the display unit 13 so that the user can input the state of the food designed to be chilled (48). When the food designed to be frozen is chilled, the user presses the chilled-state button 16 of the input unit 15. When the food designed to be frozen is frozen, the user presses the frozen-state button 17 of the input unit 15.

Subsequently, the control unit 20 determines whether the frozen-state button 17 is pressed by the user (i.e., the food designed to be frozen is frozen) (50). When it is determined that the frozen-state button 17 is pressed by the user, the control unit 20 interprets that the food designed to be frozen is frozen. Consequently, the food is thawed, and a cooking process is preformed according to the interpreted cooking conditions (52). When it is determined that the frozen-state button 17 is not pressed, on the other hand, the control unit 20 determines whether the chilled-state button 16 is pressed by the user (i.e., the food designed to be frozen is chilled) (54).

When it is determined that the chilled-state button 16 is not pressed, the procedure is returned to Operation 50. When it is determined that the chilled-state button 16 is pressed by the user, on the other hand, the cooking process is carried out according to the interpreted cooking conditions (cooking mode, cooking time, power level) without performing a thawing process (i.e., ignoring the thawing information of the cooking information confirmed by interpreting the bar code).

As can be easily understood from the above description, food is not directly cooked based on the interpreted cooking conditions when the food, designed to be frozen, is chilled. The food is cooked according to the other cooking conditions excluding the thawing time. Consequently, the food is optimally cooked.

In this embodiment, kinds of food, food name, thawing information, and various cooking conditions are included in the cooking information. It is possible, however, that only the thawing information and the cooking conditions are included in the cooking information.

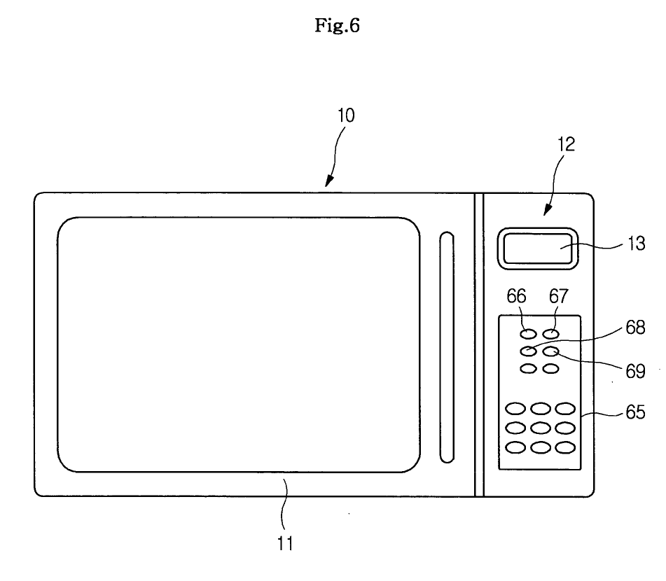

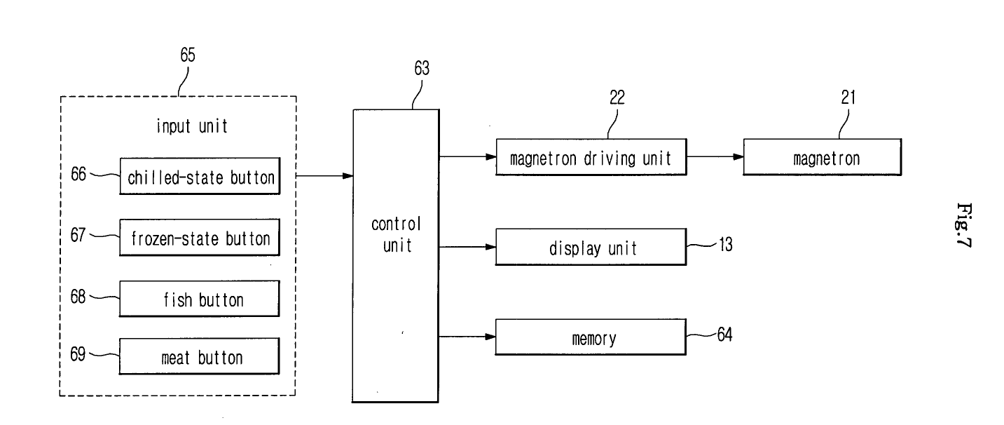

As shown in FIGS. 6 and 7, a microwave oven, which is a kind of cooking apparatus according to a second embodiment of the present invention, has food buttons disposed at an input part 65 for a user to select food to be cooked. Names of food to be cooked (for example, fish button 68 and meat button 69) are printed on the food buttons so that the user can easily select the food to be cooked. Similar to the first embodiment, the input part 65 also has a chilled-state button 66, a frozen-state button 67, and other buttons for a user to input control commands.

However, the selection of food to be cooked may be performed in other manners. For example, a direction movement button (not shown) and an enter button (not shown) may be disposed at the input unit 65. In this case, the user pushes the direction movement button so that various kinds of food to be cooked are sequentially displayed on the display unit 13, and, when the food that the user wishes to cook is displayed on the display unit 13, the user pushes the enter button to select the displayed food.

Also, the microwave oven according to the second embodiment of the present invention includes a memory 64 to store cooking information and thawing information of food designed to be chilled and cooking information of food designed to be frozen. In this case, food to be cooked is classified into food designed to be chilled and food designed to be frozen, which are stored in the memory, and cooking information is set for each food to be cooked. Cooking information of food designed to be chilled is set on the premise that the food designed to be chilled is generally in chilled storage, and cooking information of food designed to be frozen is set on the premise that the food designed to be frozen is generally in frozen storage. Consequently, thawing information is not included in the cooking information of the food designed to be chilled, and therefore, thawing information of the food designed to be chilled is separately stored. On the other hand, thawing information is included in the cooking information of the food designed to be frozen. In this case, the thawing information includes thawing time and power level, which are necessary to thaw the food designed to be chilled or the food designed to be frozen.

In this embodiment, food to be cooked is classified into food designed to be chilled and food designed to be frozen, which are stored, and a control unit 63 determines whether food to be cooked, which has arbitrary cooking information, is food designed to be chilled or food designed to be frozen. However, it is possible that kinds of food, by which it is determined whether food to be cooked is food designed to be chilled or food designed to be frozen, is included together with the cooking information such that the control unit 63 confirms the kind of food having arbitrary cooking information.

Also, the microwave oven according to the second embodiment of the present invention further includes the control unit 63 to control the respective components of the microwave oven such that a cooking process is performed according to the cooking information of the corresponding food stored in the memory 64 when the user selects the food to be cooked.

As can be seen from the above description, the first embodiment, in which the cooking information for automatic cooking is stored in the bar code, is different from the second embodiment, in which the cooking information for automatic cooking is stored in the memory 64. Other components of the microwave oven used in the second embodiment are identical to those of the microwave oven according to the first embodiment described with reference to FIGS. 1 and 2 (except the description of the bar-code reader 14 and the memory 18 shown in FIG. 2).

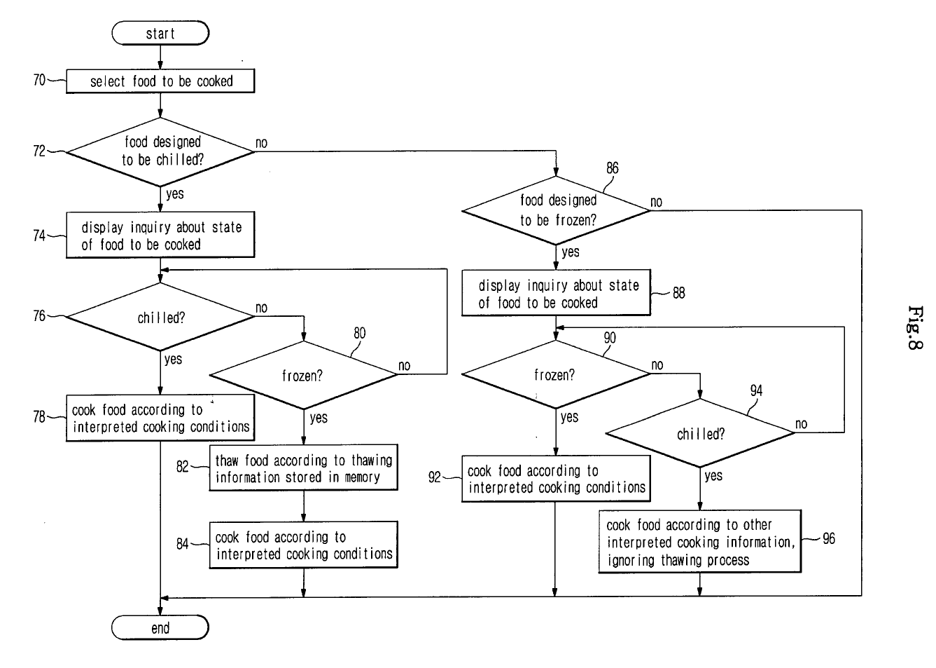

Now, a cooking method according to a second embodiment of the present invention will be described with reference to FIG. 8. When a user puts food to be cooked into the cooking chamber, and pushes the food buttons 68 and 69 of the input unit 65 to select food to be cooked, the control unit 63 searches for the cooking information of the corresponding food to be cooked in the memory 64, determines whether the food to be cooked is food designed to be chilled or food designed to be frozen (72, 86), and performs Operations 74-84 and 88-96. The second embodiment is identical to the first embodiment in that food designed to be chilled is thawed or food designed to be frozen is not thawed before cooking depending upon the state of food to be cooked. Other parts of Operations 74-84 and 88-96 are identical to the first embodiment (excluding the matters related to the bar code).

In the first and second embodiments of the present invention, food to be cooked is classified into food designed to be chilled and food designed to be frozen. However, the present invention may be applied to room-temperate storage food. This is because cooking of room-temperate storage food, which is frozen, has the same problem as cooking of food designed to be chilled, which is frozen.

As apparent from the above description, a cooking process is performed based on the current storage state of the food to be cooked when the current storage state of the food is different from the predetermined storage state of the food, i.e., when the food, designed to be chilled, is frozen, or the food, designed to be frozen, is chilled. Consequently, the present invention has the effect of accomplishing optimal cooking.

Especially, in the case that the cooking process is automatically performed using the cooking information stored in the bar code or the memory, when the food, designed to be chilled, is frozen, it is determined that it is inappropriate to cook the food according to the cooking information, and the food is thawed before cooking, and, when the food, designed to be frozen, is chilled, the food is cooked without thawing the food. Consequently, the present invention has the effect of accomplishing appropriate cooking.

Although a few embodiments of the present invention have been shown and described, it would be appreciated by those skilled in the art that changes may be made in this embodiment without departing from the principles and spirit of the invention, the scope of which is defined in the claims and their equivalents.

What is claimed is:

1. A cooking method comprising:
storing thawing information to thaw various kinds of food to be cooked in a memory of a cooking apparatus;
reading and interpreting a bar code, indicated on a package of the food to be cooked, storing kinds of food and cooking information for the food to be cooked;
confirming the stored state of the food to be cooked; and
when the kind of food for the food to be cooked is food designed to be chilled and the food to be cooked is frozen, thawing the food to be cooked according to the thawing information, and performing a cooking process based on the cooking information.

2. The cooking method according to claim 1, wherein the stored state of the food to be cooked includes a chilled state and a frozen state.

3. The cooking method according to claim 1, wherein the stored state of the food to be cooked is confirmed by input information obtained by a user's input of the state of the food to be cooked in response to a message requesting the user to input the state of the food to be cooked in the cooking apparatus.

4. The cooking method according to claim 1, wherein the thawing information includes thawing time set for each food to be cooked or power level of the cooking apparatus.

5. The cooking method according to claim 1, wherein the bar code stores food name, and the thawing information of the food to be cooked is confirmed by interpreting the bar code in the cooking apparatus to confirm the name of the food to be cooked and searching for thawing information of the food to be cooked having the corresponding food name in the memory.

6. The cooking method according to claim 1, further comprising:
when the kind of food for the food to be cooked is food designed to be chilled and the food to be cooked is chilled, performing a cooking process based on the cooking information without thawing the food to be cooked.

7. A cooking method comprising:
reading and interpreting a bar code, indicated on a package of food to be cooked, storing kinds of food, cooking information, and thawing information for the food to be cooked;
confirming the stored state of the food to be cooked; and
when the kind of food for the food to be cooked is food designed to be frozen and the food to be cooked is chilled, performing a cooking process based on the other cooking information without thawing the food to be cooked.

8. The cooking method according to claim 7, wherein the stored state of the food to be cooked includes a chilled state and a frozen state.

9. The cooking method according to claim 7, wherein the stored state of the food to be cooked is confirmed by input information obtained by a user's input of the state of the food to be cooked in response to a message requesting the user to input the state of the food to be cooked in the cooking apparatus.

10. The cooking method according to claim 7, further comprising:
when the kind of food for the food to be cooked is food designed to be frozen and the food to be cooked is frozen, thawing the food to be cooked according to the thawing information, and performing a cooking process based on the cooking information.

11. A cooking apparatus comprising:
a bar-code reader to read a bar code, indicated on a package of food to be cooked, storing kinds of food and cooking information for the food to be cooked;
a memory to store thawing information of food designed to be chilled, which is a kind of the food to be cooked;
a control unit to interpret the kind of food and the cooking information read by the bar-code reader and, when the food to be cooked, designed to be chilled, is frozen, control the food to be thawed according to the thawing information stored in the memory and to be cooked based on the cooking information; and
a driving unit to perform a cooking process according to a control command from the control unit.

12. The cooking apparatus according to claim 11, wherein the thawing information includes thawing time set for each food to be cooked or power level of the driving unit.

13. The cooking apparatus according to claim 11, wherein the bar code stores food name, and, when the food to be cooked, designed to be chilled, is frozen, the control unit interprets the bar code to confirm the name of the food to be cooked and confirms thawing information of the food to be cooked having the corresponding food name in the memory.

14. The cooking apparatus according to claim 11, further comprising:
a display unit to display a message requesting a user to input the state of the food to be cooked,
wherein the state of the food comprises a chilled state or a frozen state.

15. The cooking apparatus according to claim 14, further comprising:
an input unit having a chilled-state button, which is selected by the user when the food to be cooked is chilled, and a frozen-state button, which is selected by the user when the food to be cooked is frozen.

16. A cooking apparatus comprising:
a bar-code reader to read a bar code, indicated on a package of food to be cooked, storing kinds of food, cooking information, and thawing information for the food to be cooked;
a control unit to interpret the cooking information read by the bar-code reader and, when the food to be cooked, designed to be frozen, is chilled, control the food to be cooked based on the cooking information without thawing the food to be cooked; and
a driving unit to perform a cooking process according to a control command from the control unit.

17. The cooking apparatus according to claim 16, further comprising:
a display unit to display a message requesting a user to input the state of the food to be cooked,
wherein the state of the food comprises a chilled state or a frozen state.

18. The cooking apparatus according to claim 17, further comprising:
an input unit having a chilled-state button, which is selected by the user when the food to be cooked is chilled, and a frozen-state button, which is selected by the user when the food to be cooked is frozen.

19. A cooking method comprising:
storing kinds of food, cooking information, and thawing information for food to be cooked in a memory of a cooking apparatus;
searching for the cooking information of food to be cooked, which is selected by a user, in the memory;
confirming the stored state of the food to be cooked; and
when the kind of food for the food to be cooked is food designed to be chilled and the food to be cooked is frozen, thawing the food to be cooked according to the thawing information stored in the memory, and performing a cooking process based on the cooking information stored in the memory.

20. The cooking method according to claim 19, further comprising:
when the kind of food for the food to be cooked is food designed to be chilled and the food to be cooked is chilled, performing a cooking process based on the cooking information without thawing the food to be cooked.

21. A cooking method comprising:
storing kinds of food, cooking information, and thawing information for food to be cooked in a memory of a cooking apparatus;
searching for the cooking information of food to be cooked, which is selected by a user, in the memory;
confirming the stored state of the food to be cooked; and
when the kind of food for the food to be cooked is food designed to be frozen and the food to be cooked is chilled, performing a cooking process based on the other cooking information stored in the memory excluding the thawing information.

22. The cooking method according to claim 19 or 21, wherein the stored state of the food to be cooked includes a chilled state and a frozen state, and the stored state of the food to be cooked is confirmed by input information obtained by a user's input of the state of the food to be cooked in response to a message requesting the user to input the state of the food to be cooked in the cooking apparatus.

23. A cooking apparatus comprising:
a memory to store kinds of food, cooking information, and thawing information for food to be cooked;
an input unit having a chilled-state button, which is selected when the food to be cooked is chilled, and a frozen-state button, which is selected when the food to be cooked is frozen;
a control unit to control the food to be thawed according to the thawing information and then the food to be cooked based on the cooking information, when the kind of food for the food to be cooked is food designed to be chilled and the food to be cooked is frozen; and
a driving unit to perform a cooking process according to a control command from the control unit.

24. A cooking apparatus comprising:
a memory to store kinds of food, cooking information, and thawing information for food to be cooked;
an input unit having a chilled-state button, which is selected when the food to be cooked is chilled, and a frozen-state button, which is selected when the food to be cooked is frozen;
a control unit to control the food to be cooked based on the other cooking information excluding the thawing information without thawing the food to be cooked, when the kind of food for the food to be cooked is food designed to be frozen and the food to be cooked is chilled; and
a driving unit to perform a cooking process according to a control command from the control unit.

25. The cooking apparatus according to claim 23 or 24, further comprising:
a display unit to display a message requesting a user to input the state of the food to be cooked.
